(19) United States
(12) Patent Application Publication
(10) Pub. No.: US 2022/0038765 A1
(43) Pub. Date: Feb. 3, 2022

(54) METHOD AND APPARATUS FOR TWO-STEP FAVORITE/RECOMMENDED APP LAUNCH

(71) Applicant: ARRIS Enterprises LLC, Suwanee, GA (US)

(72) Inventor: Cesar A. MORENO, Santa Rosa Beach, FL (US)

(73) Assignee: ARRIS Enterprises LLC, Suwanee, GA (US)

(21) Appl. No.: 17/382,659

(22) Filed: Jul. 22, 2021

Related U.S. Application Data
(60) Provisional application No. 63/058,547, filed on Jul. 30, 2020.

(51) Int. Cl. H04N 21/422; H04N 21/431; H04N 21/482; H04N 21/41

(52) U.S. Cl. CPC H04N 21/42201; H04N 21/4126; H04N 21/482; H04N 21/431

(57) ABSTRACT

Technologies are disclosed for launching an application or service on a smart media device, such as a smart TV, set top box, or smart phone. An input mechanism, that is responsive to manual gestures of a user, generates signals that control a display associated with the smart media device. A first user gesture causes the processor to generate a menu that includes an image of a plurality of images that correspond to a first plurality of preselected applications and/or services. A second user gesture causes the processor to launch the application or service on the menu that is identified as desired for selection by the user. Preferably, the input mechanism is either a remote control unit, a keyboard, a handheld smart media device, or a smart phone.

### TECHNICAL FIELD

The present disclosure relates generally to a method and apparatus for controlling a Smart Media Device (“SMD”) such as a smart TV, or a set top box (“STB”), or a smart phone, and more particularly to controlling an SMD with a remote control unit (“RCU”), keyboard, or touch screen, in order to provide a simplified way for quickly launching favorite or recommended applications or services.

### BACKGROUND

Remote control units for controlling a television, an SMD or an STB are well known in the art. The RCU has various buttons that control various functionalities relating to the device being controlled. For example, buttons on the RCU may take a user to a guide screen, change channels up or down, or access other applications associated with the television, SMD or STB. The RCU is programmed to recognize the actuation of keys or control surfaces associated with the various functionality. Typically, the signals generated by an RCU are transmitted to the television or SMD over a wireless RF link or an IR optical link.

Consumers typically have multiple SMD's located in their homes, and these SMD devices may be connected to TV's for video display, a computer monitor, or may be mobile handheld devices having their own displays. Typically, when a user is watching an SMD which is not readily mobile, the SMD is not typically within the easy reach of the user when being viewed, and an RCU is considered a necessity for controlling the SMD. However, it is often time consuming and frustrating for a consumer to press multiple buttons to access a desired channel or service being displayed on the SMD. For example, if a user is watching a program on one channel and wants to either watch a different program on another channel or see what is on other channels, he/she will typically depress a “guide” button which will take the user to a guide screen. If the user wants to view his/her saved favorites, they will need to depress another button to access their favorites. Then, then will select a program or app from their favorites screen. This requires at least three gestures (or launch sequences) from the user, and possibly four or more, to be able to access and select a program or app from their favorites screen.

Handheld mobile SMD's, such as a mobile smart phone, can be used as a stand-alone SMD, or it can run an app which permits it to function as an RCU. An example of an RCU app that converts a smart phone into an RCU is the Roku app which is available from the Apple App Store or the Google Play Store. As a standalone SMD, mobile smart phones can have menus that are cumbersome and often difficult and time consuming to operate. Accordingly, as RCUs and smart phones become more complex and the number of apps/services available to consumers become more numerous, there is a need to provide users with quicker and simpler ways to access their favorite apps and services.

The present disclosure is directed toward overcoming one or more of the above-identified problems, though not necessarily limited to embodiments that do.

### SUMMARY

The present disclosure provides a simple two-step launch sequence that can be used by a user to access favorite/recommended applications or services which are accessible on an SMD. The apparatus and method preferably utilizes a predetermined “long press” button on a remote control or keyboard that launches a “quick launch” menu, where up to four app/services can be displayed on the user's SMD display. The user can then simply access the app/services via the D-Pad navigation buttons (up, down, left, right) by pressing a navigation button corresponding to the desired app/services displayed on the screen.

A media control device may be configured to launch an application or service on a smart media device. The media control device may comprise an input mechanism, responsive to manual user gestures, for generating signals that control a display associated with the smart media device, and a processor, responsive to the input mechanism, for generating image data to be displayed on the display associated with the smart media device. A first user gesture (e.g., prolonged depress of a button or key) may cause the processor to generate a menu that includes an image of a plurality of images that correspond to a first plurality of preselected applications and/or services. A second user gesture may cause the processor to launch the application or service on the menu that is identified as desired for selection by the user. In this way, only two gestures are required, and not three or more.

Additional features, aspects, objects, advantages, and possible applications of the present disclosure will become apparent from a study of the exemplary embodiments and examples described below, in combination with the Figures, and the appended claims.

### BRIEF DESCRIPTION OF THE DRAWINGS

FIG. 1 is an illustration of an RCU having D-Pad navigation buttons, as well as a plurality of other buttons for controlling functions of an SMD and other related devices;

FIG. 2 is an illustration of an RCU having a predetermined apps button and D-Pad navigation buttons, as well as a plurality of other buttons for controlling functions of the SMD;

FIG. 3 is an illustration of a display screen having an image of a centrally located D-pad surrounded by four examples of apps/services that may be selected by the user or recommended by a manufacturer or service provider;

FIG. 4 is a flow diagram illustrating how a user can interacts with a “quick launch” menu and an RCU to quickly select an app/service displayed on an SMD screen or the screen of a mobile smart phone;

FIGS. 5A and 5B illustrate a handheld smart phone with a D-pad preferably having a “long press” button and a “quick launch” menu; and

FIG. 6 illustrates a representative computer system operable to facilitate user interaction with a “quick launch” menu and an RCU to quickly select an app/service displayed on an SMD screen or the screen of a mobile smart phone in accordance with an exemplary embodiment of the present disclosure.

### DETAILED DESCRIPTION

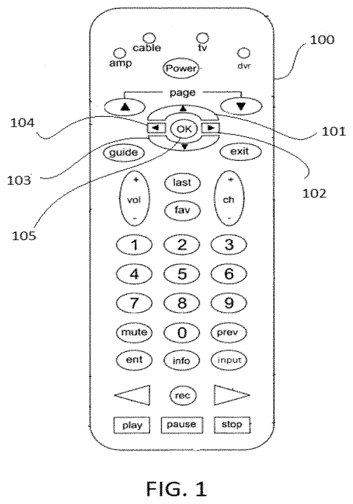

Referring now to FIG. 1, there is an illustration of an RCU 100 that can be used in the exemplary embodiments disclosed herein. Visually, the RCU 100 resembles a conventional RCU of the type well-known in the art, but in accordance with this disclosure the RCU 100 has been modified to include at least one “long press” button for performing the first step which includes a “quick launch” menu for quickly selecting apps/services. The term “long press” button is a well-known term in the art, and means the prolonged depression of a button for a predetermined extended period of time, such as, for example, one or two seconds, or longer. If a “long press” button is depressed for a relatively brief time period, it generates a signal for a first function, but if it is depressed for an extended period of time, it generates a second signal for an alternate function. If desired, multiple keys of the RCU 100 could be “long press” buttons, and a consumer could begin the first step of the quick selection process by depressing any one of the “long press” buttons on the RCU 100 for a predetermined extended period of time, such as, for example, one or two seconds, or longer. The RCU 100 also includes a D-pad which includes four navigation keys 101, 102, 103, and 104, and an “OK” button 105. Preferably, in one embodiment, the “OK” button 105 is a “long press” button that can initiate the first step of quick launch procedure by initiating the “quick launch” menu. The second step of the quick launch procedure is performed by depressing one of the four navigation keys 101, 102, 103, and 104. The term D-pad is also a well-known term in the art, but it sometimes simply referred to as “navigation keys” or “directional keys.”

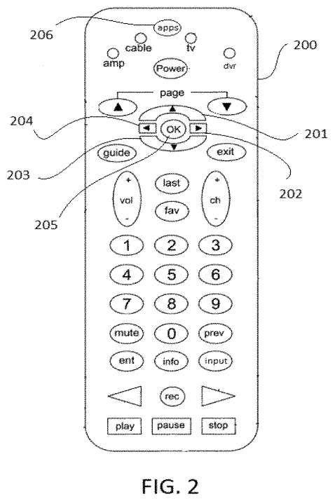

Referring now to FIG. 2, there is an illustration of an RCU 200 that can be used in another exemplary embodiment disclosed herein. Visually, the RCU 200 also resembles a conventional RCU, but in accordance with this disclosure the RCU 200 has been modified to include a button 206 labeled “apps” or some other descriptive name. Preferably, the button 206 is a “long press” button which initiates an extensive menu of apps or programs if it is depressed briefly, and launches the “quick launch” menu if it is depressed for an extended period of time. The quick launch menu will have a plurality of apps or programs that is less than that provided by the extensive menu. In other words, the user performs the first step of the quick launch procedure by depressing the apps button 206 for an extended or prolonged period of time. The RCU 200 also includes a D-pad which includes four navigation keys 201, 202, 203, and 204, as well an “OK” button 205. In this embodiment, the user performs the second step of the quick launch procedure by depressing or actuating one of the navigation keys 201, 202, 203, and 204, as described below.

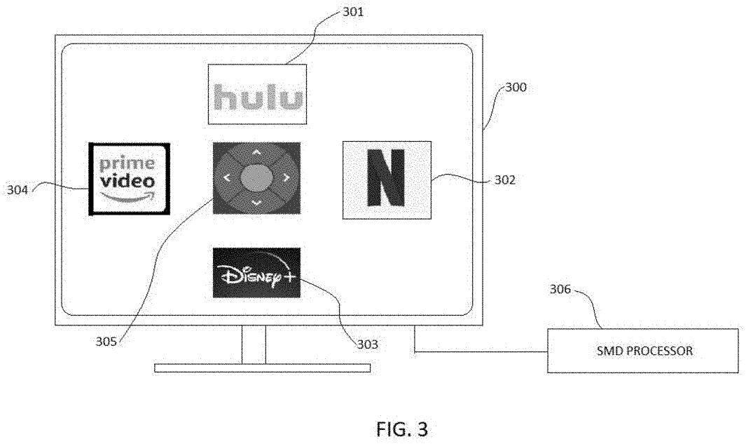

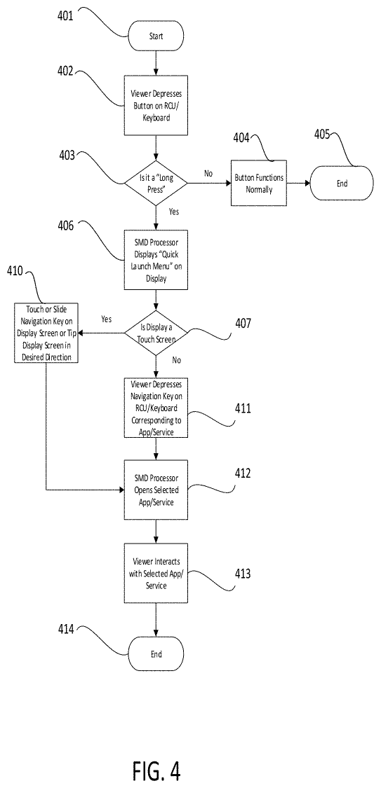

Referring now to FIG. 3, there is an illustration of a television, computer display, or other SMD display 300. The SMD display 300 is connected to a SMD processor 306 which can be integrated into the SMD display 300 or which can be implemented as a standalone device, as illustrated in FIG. 3. As explained in more detail below, it should also be noted that a smart phone or other hand-held device could include a SMD touch screen display 300 which is integrated together in a single device with a SMD processor 306. When the user of the display 300, depresses the predetermined “long press” button of the RCU 100 or depresses “long press” apps button 206 of RCU 200, the SMD processor 306 generates an image of the “quick launch” menu which is displayed on the SMD display 300. Preferably, in response to the prolonged depression of the button, the “quick launch” menu displayed on SMD display 300 includes a limited plurality of icons, logos, or text identifying predetermined apps/services including popular video streaming services. These predetermined apps/services may be selected for inclusion in the “quick launch” menu by the user, or alternatively the apps/services may be selected by the manufacturer of the SMD 300 or SMD processor 306. While four apps/services are shown in FIG. 4, any number can be implemented. For example, the user may want to select his/her four (or more or less) most used apps/services or perhaps his/her four (or more or less) most favorite apps/services for inclusion on the “quick launch” menu. These predetermined apps/services of the “quick launch” menu could also be selected by a service such as an Internet Service Provider or a Cable TV Company.

In one embodiment, the image displayed on the SMD display 300 also includes an image of a D-pad 305 having directional/navigation keys 305, 305b, 305c, 305d. The image of the D-pad 305 is preferably located centrally of the displayed icons, logos, or text 301, 302, 303, 304. The D-pad 305 can also be included solely on the RCU 100, 200, or on both the display 300 and the RCU 100, 200.

Referring now to FIGS. 3 and 4, a flow diagram illustrates the logic and operation of the preferred embodiments. The quick launch procedure begins with a start step 401, and in step 402 the user preferably depresses a “long press” button on the RCU/keyboard. In step 403, a processor responsive to the RCU/keyboard determines whether the user has depressed the “long press” key for an extended period of time. If the “long press” key has not been depressed for the minimum extended period of time then, in step 404, the “long press” key generates a first signal which causes the button to function normally, and it does not initiate the “quick launch” menu. The process is ended in step 405.

If in step 403, however, the SMD processor 306 determines that the “long press” key has been depressed for the required extended period of time, then a second signal is generated and, in step 406, the SMD processor 306 causes the “quick launch” menu to appear on the SMD display 300. In step 407, if the SMD processor 306 determines that there is no touch screen display present then, in step 411, the user can depress the navigation key on the RCU/keyboard corresponding to one of the navigation keys 305a, 305b, 305c, or 305d appearing on the display 300. The navigation keys 305a, 305b, 305c, 305d are positioned such that they preferably point in the direction of a selectable app/service. In step 412, the depressed navigation key causes the SMD processor 306 to select and open the corresponding app/service appearing in the “quick launch” menu on the SMD display 300. In step 413, the user interacts with the selected app/service. The process is then ended in step 414.

If a determination is made in step 407, that the SMD display 300 is a touch screen, then the user can actuate one of the navigation keys 305, 305b, 305c, or 305d displayed on the touch screen of SMD display 300 corresponding to the desired app/service also displayed in the “quick launch menu” on the SMD display 300. The actuation of the navigation keys 305, 305b, 305c, or 305d can be achieved by the user either pressing directly on the desired navigation key of the touch screen or by sliding his or her finger in the direction of the navigation key. Alternatively, if the SMD screen 300 is part of a handheld device and the handheld device has a motion sensing device, e.g., an accelerometer, then the handheld device can be tipped in the direction of the desired navigation key, thereby actuating the desired navigational key.

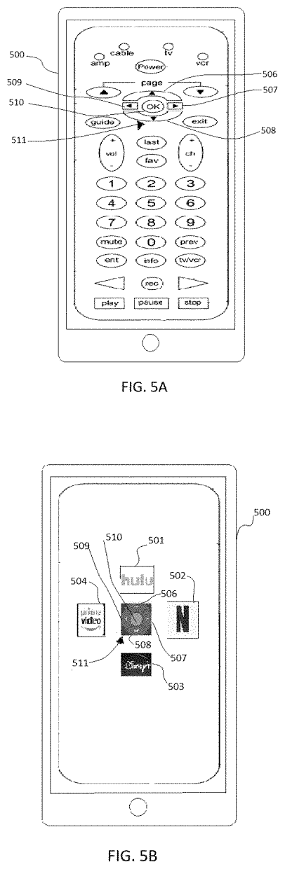

Referring now to FIGS. 5A and 5B, there are illustrations of a smart phone 500 with a touch screen which has been modified to include the two-step launch sequence disclosed herein. In FIG. 5A, there is an illustration of the smart phone 500 running a remote control app which has a D-pad 511 including navigation keys 506, 507, 508, and 509. There is also a centrally located OK button 510 which is preferably a “long press” button. When a user depresses the “long press” “OK” button 510 for a predetermined period of time, the “quick launch” menu is opened and displayed as illustrated in FIG. 5B. The quick launch menu of FIG. 5B provides the user with a centrally located image of the D-pad 511 having the four navigation keys 506, 507, 508, and 509 as well as the centrally located “OK” button 510. The D-pad 511 is preferably surrounded by icons of four apps/services 501, 502, 503, and 504. To launch the desired app/service, the user actuates a navigation key by pressing the navigation key corresponding to app/service or sliding his/her finger along the navigation key toward the desired app/service, and then press a selection key to select the app/service. For example, if the user desires to launch app/service 501 the user would press navigation key 506 or slide his/her finger upward in the direction of the icon for app/service 501. Alternatively, if the smart phone is equipped with a motion sensing device such as an accelerometer, the user could tilt the smart phone 500 upward to select the app/service 501 and then depress a selection key to launch the app/service 501.

The present disclosure thus reduces the steps or gestures required to select a favorite app or service from a traditional three or four sequence launch sequence to a more streamlined two-step launch sequence. In a traditional launch sequence, a user first depresses a guide key to take him/her to a guide screen (step 1); then depresses a key to take him/her to a favorites screen (step 2); and finally depresses a key to select an app or service from the favorites screen (step 3). In accordance with the present disclosure, a user need only depress a key once for a prolonged period of time to access the favorites screen (step 1); and then depress a key to select an app or service from the favorites screen (step 2). Thus, only two steps/gestures are required to select a desired app or service, and not the traditions three or four steps/gestures.

### Computer System Architecture

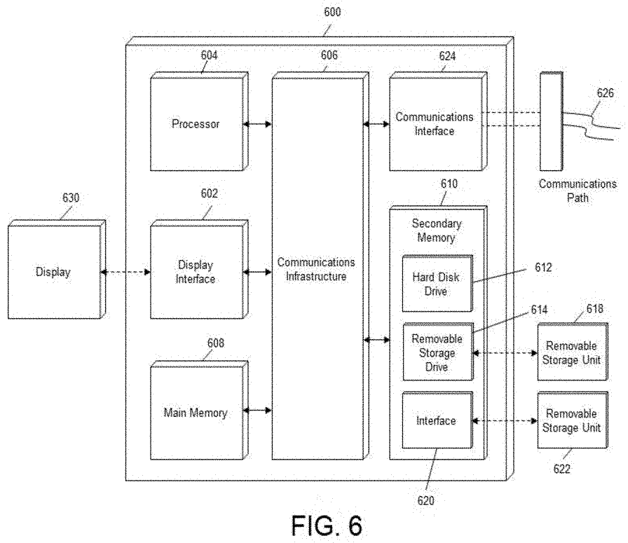

FIG. 6 illustrates a representative computer system 600 in which embodiments of the present disclosure, or portions thereof, may be implemented as computer-readable code. For example, the processor of the RCU/keyboard 100, 200 or the SMD 306 processor may be implemented in whole or in part by a computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods and steps of the present disclosure.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this representative computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device specifically configured to perform the functions discussed herein. The processor device 604 may be connected to a communications infrastructure 606, such as a bus, message queue, network, multi-core message-passing scheme, etc. The network may be any network suitable for performing the functions as disclosed herein and may include a local area network (“LAN”), a wide area network (“WAN”), a wireless network (e.g., “Wi-Fi”), a mobile communication network, a satellite network, the Internet, fiber optic, coaxial cable, infrared, radio frequency (“RF”), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIG. 4, as discussed herein. Accordingly, such computer programs may represent controllers of the computer system 600. Where the present disclosure is implemented using software executed on hardware, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software executed on hardware, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for generating signals to control a smart media device. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A media control device configured to launch an application or service on a smart media device, the device comprising:
an input mechanism, responsive to manual user gestures, for generating signals that control a display associated with the smart media device; and
a processor, responsive to the input mechanism, for generating image data to be displayed on the display associated with the smart media device; wherein:
a first user gesture causes the processor to generate a menu that includes an image of a plurality of images that correspond to a first plurality of preselected applications and/or services; and
a second user gesture causes the processor to launch the application or service on the menu that is identified as desired for selection by the user.

2. The media control device according to claim 1, wherein the first plurality of preselected applications and/or services comprises applications and/or services preselected by the user and designated as favorites.

3. The media control device according to claim 1, wherein:
the device comprises a remote control unit having a plurality of buttons including a plurality of directional navigation keys and at least one button which is a dedicated long press button;
depression of the dedicated long press button for a prolonged period of time is the first user gesture that causes the processor to generate the menu; and
upon identifying a desired application or service using the plurality of directional navigation keys, depression of a selection key is the second user gesture that causes the processor to launch the desired application or service.

4. The media control device according to claim 1, wherein:
the device comprises a keyboard having a plurality of keys including a plurality of directional navigation keys and at least one key which is a dedicated long press key;
depression of the dedicated long press key for a prolonged period of time is the first user gesture that causes the processor to generate the menu; and
upon identifying a desired application or service using the plurality of directional navigation keys, depression of a selection key is the second user gesture that causes the processor to launch the desired application or service.

5. The media control device according to claim 1, wherein:
the device comprises a handheld smart media device having a touch screen with a plurality of actuatable buttons including a plurality of directional navigation keys and at least one button which is a dedicated long press button, wherein the plurality of actuatable buttons may be actuated by either a touch or a swipe of the touch screen;
actuation of the dedicated long press button is the first user gesture that causes the processor to generate the menu; and
upon identifying a desired application or service using the plurality of directional navigation keys, actuation of a selection button is the second user gesture that causes the processor to launch the desired application or service.

6. The media control device according to claim 1, wherein:
the device comprises a smart phone having a touch screen with a plurality of actuatable buttons including a plurality of directional navigation keys and at least one button which is a dedicated long press button, wherein the actuatable buttons may be actuated by either a touch or a swipe of the touch screen;
actuation of the dedicated long press button is the first user gesture that causes the processor to generate a menu; and
upon identifying a desired application or service using the plurality of directional navigation keys, actuation of a selection key is the second user gesture that the causes the processor to launch the desired application or service.

7. The media control device according to claim 6, wherein the desired application or service is identified via a tilting of the smart phone.

8. The media control device according to claim 1, wherein the menu includes a plurality of directional navigation keys used to identify the desired application or service for selection by the user.

9. The media control device according to claim 8, wherein the plurality of directional navigation keys are in the shape of a centrally located D-pad which is surrounded by the plurality of images that correspond to first plurality of preselected applications and/or services.

10. The media control device according to claim 9, wherein the first plurality of preselected applications and/or services comprise four preselected applications and/or services positioned one each above and below and on either side of the centrally located D-pad.

11. A method for launching an application or service from a smart media device performed by a media control device, the method comprising:
in response to sensed manual gestures, generating signals that control a display associated with the smart media device;
processing the manual gestures and generating image data to be displayed on the display associated with the smart media device; wherein
a sensed first user gesture causes the processor to generate a menu that includes an image of a plurality of images that correspond to a first plurality of preselected applications and/or services; and
a sensed second user gesture causes the processor to launch the application or service on the menu that is identified as desired for selection by the user.

12. The method according to claim 11, wherein the first plurality of preselected applications and/or services comprises applications and/or services preselected by the user and designated as favorites.

13. The method according to claim 11, wherein the media control device comprises a remote control unit having a plurality of buttons including a plurality of directional navigation keys and at least one button which is a dedicated long press button, the method further comprising:
sensing depression of the dedicated long press button for a prolonged period of time as indicative of the first user gesture that causes the processor to generate the menu; and
upon identifying a desired application or service using the plurality of directional navigation keys, sensing depression of a selection key as indicative of the second user gesture that causes the processor to launch the desired application or service.

14. The method according to claim 11, wherein the media control device comprises a keyboard having a plurality of keys including a plurality of directional navigation keys and at least one key which is a dedicated long press key, the method further comprising:
sensing depression of the dedicated long press key for a prolonged period of time as indicative of the first user gesture that causes the processor to generate the menu; and
upon identifying a desired application or service using the plurality of directional navigation keys, sensing depression of a selection key as indicative of the second user gesture that causes the processor to launch the desired application or service.

15. The method according to claim 11, wherein the media control device comprises a handheld smart media device having a touch screen with a plurality of actuatable buttons including a plurality of directional navigation keys and at least one button which is a dedicated long press button, wherein the plurality of actuatable buttons may be actuated by either a touch or a swipe of the touch screen, the method further comprising:
sensing actuation of the dedicated long press button as indicative of the first user gesture that causes the processor to generate the menu; and
upon identifying a desired application or service using the plurality of directional navigation keys, sensing actuation of a selection button as indicative of the second user gesture that causes the processor to launch the desired application or service.

16. The method of claim 11, wherein the media control device comprises a smart phone having a touch screen with a plurality of actuatable buttons including a plurality of directional navigation keys and at least one button which is a dedicated long press button, wherein the actuatable buttons may be actuated by either a touch or a swipe of the touch screen, the method further comprising:
Sensing actuation of the dedicated long press button as indicative of the first user gesture that causes the processor to generate a menu; and
upon identifying a desired application or service using the plurality of directional navigation keys, sensing actuation of a selection key as indicative of the second user gesture that the causes the processor to launch the desired application or service.

17. The method according to claim 16, wherein the step of sensing actuation of a selection key as indicative of the second user gesture that the causes the processor to launch the desired application or service comprising sensing a tilting of the smart phone.

18. The method according to claim 11, wherein the menu includes a plurality of directional navigation keys used to identify the desired application or service for selection by the user.

19. A non-transitory computer readable medium having instructions stored thereon, the instructions causing at least one processor of a media control device to perform one or more operations for launching an application or service from a smart media device, the one or more operations comprising:
in response to sensed manual gestures, generating signals that control a display associated with the smart media device;
processing the manual gestures and generating image data to be displayed on the display associated with the smart media device; wherein
a sensed first user gesture causes the processor to generate a menu that includes an image of a plurality of images that correspond to a first plurality of preselected applications and/or services; and
a sensed second user gesture causes the processor to launch the application or service on the menu that is identified as desired for selection by the user.

20. The non-transitory computer readable medium according to claim 19, wherein the first plurality of preselected applications and/or services comprises applications and/or services preselected by the user and designated as favorites.
